(19) United States
(12) Patent Application Publication
(10) Pub. No.: US 2024/0164263 A1
(43) Pub. Date: May 23, 2024

(54) THREE-DIMENSIONAL GROUND VEGETATION REINFORCEMENT STRUCTURE WITH CONCOMITANT PLANT STARTING MATERIAL.

(71) Applicant: CAREY WIDDER, ST. LOUIS, MO (US)

(72) Inventor: CAREY WIDDER, ST. LOUIS, MO (US)

(21) Appl. No.: 17/992,846

(22) Filed: Nov. 22, 2022

(51) Int. Cl. A01G 20/20; A01G 24/46

(52) U.S. Cl. CPC A01G 20/20; A01G 24/46

(57) ABSTRACT

A three-dimensional ground vegetation reinforcement structure within which a plurality of seeds for a selected plant are disposed at or near a plant starting material connected to a three dimensional structure wherein the three dimensional structure has a plurality of apertures to allow the selected plant to grow through the apertures and further including upper elements in the general form and shape of the vegetative parts of the selected plant such that the vegetative parts of the upper elements are artificial and represent the matured portion of the selected plant until the seeds of the selected plant germinate and grow to maturity, and wherein the three dimensional structure has a base portion at the bottom of the three dimensional structure.

### CROSS REFERENCE TO RELATED APPLICATIONS

Not applicable

### STATEMENT REGARDING FEDERALLY SPONSORED RESEARCH

Not applicable

### BACKGROUND OF THE INVENTION

Since the domestication of animals, humans have been selecting ground covers for grazing nutrition and plant persistence. More recently, ground covers such as turf grasses have been designed for ornamental and recreational purposes. However, nearly all contemporary functional and ornamental ground covers can suffer catastrophic defoliation from grazing, foot, and wheel traffic, and/or bladed implements of ground cover husbandry. One process of catastrophic defoliation is ground level or near-ground level shearing of the plant crown or shoot meristem. The shoot meristem is the above-ground portion of the plant where cell division occurs for both new plant growth and regrowth after injury.

Previous matting systems fail to provide the correct combination of resilient plastic matting that serves to provide an artificial grass while simultaneously providing openings within the resilient plastic matting that allow seeds disposed on a base material to grow through a series of openings in the resilient plastic matting to allow growth of the grass. While there are many mats designed to facilitate vegetation growth, none of those previous embodiments are specifically designed as a seed-specific and/or plant-specific, all-in-one vegetation growth solution that is specifically engineered to protect against mechanical shear.

What is needed is a structurally reinforced ground-level terrestrial ecosystem that protects shoot meristems when subjected to mechanical stress because careful preservation of the shoot meristem within the ecosystem improves continued plant viability, which in turn increases gas exchange within the ecosystem over time. When water is available within the plant, this gas exchange involves the aspiration of water vapor, which gives a desired localized cooling effect. Additionally, the same gas exchange process sequesters carbon dioxide within the ecosystem.

In view of these objectives, it is desirable to design a three-dimensional ground vegetation reinforcement structure that provides an appearance similar to natural grass while also providing the conditions that allow an array of grass seed to grow within the matrix of the reinforcement structure. Certain embodiments of the present invention generally overcome the problem of failed vegetation where mechanical shear, usually caused by foot and wheel traffic livestock grazing, or bladed implements of husbandry would prevent robust vegetation growth. The embodiments described herein provide the solution to mechanical shear and inability to grow vegetation in an all-in-one solution.

### SUMMARY OF THE INVENTION

This section provides a general summary of the disclosure, and is not a comprehensive disclosure of its full scope or all of its features. In accordance with the various embodiments of the present invention, this invention relates to three-dimensional ground vegetation reinforcement structure with concomitant plant starting material.

Further areas of applicability will become apparent from the description provided herein. The descriptions in this summary are intended for purposes of illustration only and are not intended to limit the scope or the claims of the present disclosure.

### DESCRIPTION OF THE DRAWINGS

In the accompanying drawings which form part of the specification:

FIG. 1 is side viewing showing the damaging action that can occur when freshly sown grass is walked upon;

FIG. 2 is an isometric view of one embodiment of the present invention;

FIG. 3 is an exploded view of one embodiment of the present invention; and,

FIG. 4 is a side isometric view showing how one embodiment of the invention has been installed and operates in one typical application.

Corresponding reference numerals indicate corresponding steps or parts throughout the several figures of the drawings.

While specific embodiments of the present invention are illustrated in the above referenced drawings and in the following description, it is understood that the embodiments shown are merely some examples of various preferred embodiments and are offered for the purpose of illustration only, and that various changes in construction may be resorted to in the course of manufacture in order that the present invention may be utilized to the best advantage according to circumstances which may arise, without in any way departing from the spirit and intention of the present invention, which is to be limited only in accordance with the claims contained herein.

### DETAILED DESCRIPTION OF AT LEAST ONE PREFERRED EMBODIMENT OF THE INVENTION

In the following description, numerous specific details are set forth such as examples of some preferred embodiments, specific components, devices, and methods, in order to provide a thorough understanding of embodiments of the present disclosure. It will be apparent to a person of ordinary skill in the art that these specific details need not be exclusively employed, and should not be construed to limit the scope of the disclosure. In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication, and manufacture for those of ordinary skill.

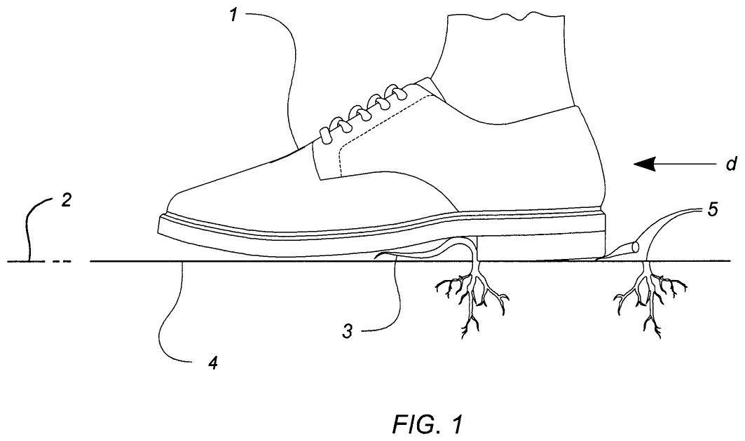

At least one preferred embodiment of the present invention is illustrated in the drawings and figures contained within this specification. More specifically, some preferred embodiments of the present invention are generally disclosed and described in FIGS. 1 through 4.

Referring now to FIG. 1, it is a common problem for the growing of new plants to have a shoe walk on the new plant to damage the growing plant. FIG. 1 shows an example of such a situation where a shoe 1 moves in a horizontal motion “d” along a plane 2 over a ground 4 in such a way as to shear portions of a growing plant 3 to result in a sheared plant 5. The damage is caused by the shearing action of the shoe 1 as it moves onto and over the growing plant 3.

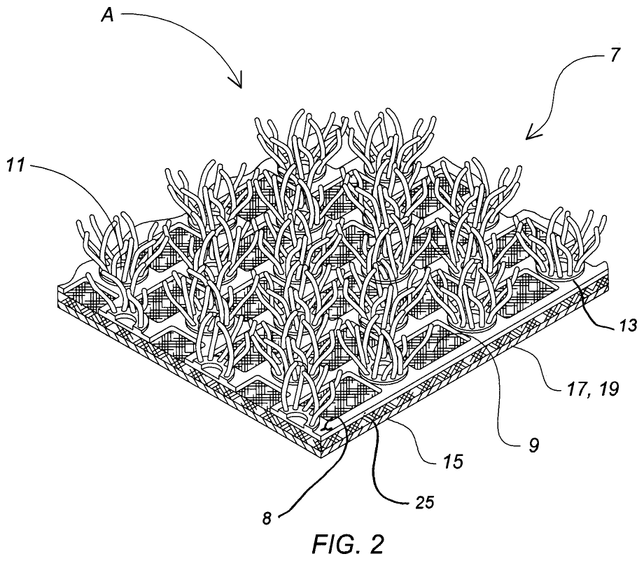

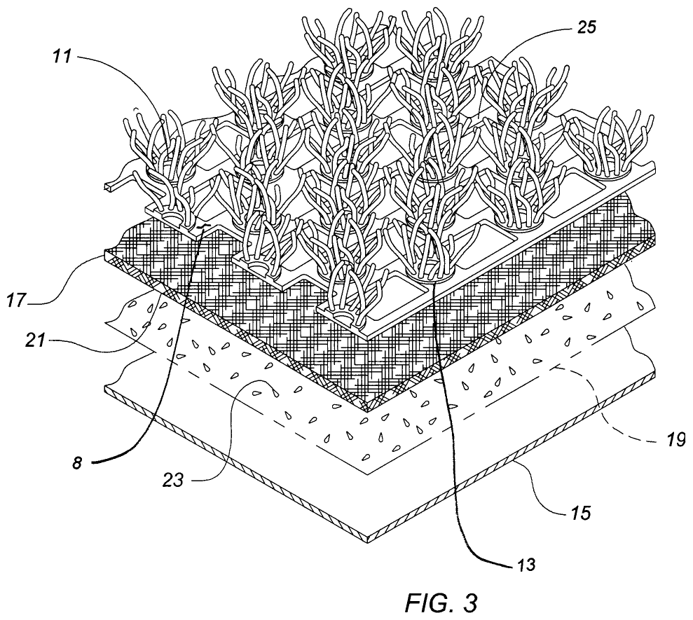

In resolving this common problem, the various preferred embodiments of the present invention include certain components arranged and stacked in various vertical orders and sequences. It is appreciated that other components may be added to each of those vertical orders and remain within the intended scope of the various claims. It will be noted that each of the preferred embodiments contain various combinations of two or more of a selected set of elements shown in FIG. 2 and FIG. 3 that includes a plurality of upper elements 11, a protective base 15, a plant starting material layer 17, a layer of seeds 19, and a base attachment structure 25. Other elements disclosed herein can also be added as required by the specific embodiments. As will be explained below, these components are arranged in various vertical orders wherein these components are stacked in various sequences and orders to generate certain of the various preferred embodiments disclosed herein.

Referring now to FIG. 2 and FIG. 3, one embodiment of the invention that includes a plant material-impregnated three-dimensional protective structure that has the appearance of ground cover and protects the resulting natural ground cover from certain activities that might damage or destroy any seeds included as part of the present embodiment

In FIG. 2 and FIG. 3, one embodiment of the invention that includes a plant material-impregnated three-dimensional protective structure A that has the appearance of ground cover and protects the resulting natural ground cover from certain activities that might damage or destroy any seeds included as part of the present embodiment. More specifically, the current embodiment of the invention includes a base attachment structure 25 having a plurality of apertures 2, a plurality of upper elements 11 generally designed to bend and flex when subjected to strain and mechanical stress, a plurality of vertical upper bases 13 wherein the plurality of upper elements is disposed on the upper portion of the vertical upper base, a layer of plant seeds 19 (FIG. 3) disposed near the plant starting material layer, and a protective base 15 disposed at the bottom of the layer of plant seeds 19.

It is understood that the plant starting material layer 17 in the present embodiment is sputtered or sprayed as a slurry or otherwise distributed upon the base attachment 25.

In a preferred embodiment (See FIG. 2 and FIG. 3), each of the plurality of upper elements 11 generally comprise a field network of synthetic vertical elastic components with a “subulate” leaf-like appearance that is made from Low Density Polyethylene LDPE. Each of the plurality of upper elements 11 is about 20 mm in height, about 2 mm wide, and about 1 mm thick near a lower portion of each of the upper elements, tapering to between about 1.5 mm and about 0.5 mm thick at upper portion of the upper elements.

It is understood that each of the plurality of upper elements 11 of the present embodiment is independently resilient in that it remains generally upright after being bent into a non-vertical position. This is to say, each of the plurality of upper elements 11 has an elastic bending limit such that normal foot or wheeled traffic does not unacceptably and permanently plastically deform any of the plurality of upper elements.

Additionally, in the present embodiment, each of the plurality of upper elements 11, the upper element has a monomeric cross-section, that is symmetric about one axis, simulating a turf grass leaf with one central vein and a narrow lamina that together give vertical bending strength similar to evergreen lignified sclerenchyma tissue. The dispersion of the plurality of upper elements 11 is designed to allow the plurality of upper elements to be disposed near each adjacent upper element in a manner that allows the field of upper elements to minimize any blocking of light energy to the shoot meristem of the plant.

The layer of plant starting material layer 17 is also disposed at a location beneath the base attachment structure 25, wherein a layer of seeds 19 is generally disposed at the layer of plant starting material layer. In certain embodiments of the present invention, the plant starting material layer 17 is generally composed of earth soil.

It is understood that the general composition of the layer of seeds 19 in one embodiment of the present invention includes at least one of either seeds, seedlings, cuttings, ground-up plant material, spores, or any other material that includes organic material that is capable of germinating and growing through the plurality of apertures 9 disposed in the base attachment structure 25. It is also understood that in certain embodiments, the layer of seeds 19 is disposed in a manner that locates at least a portion of the seeds a distance away from the layer of plant starting material layer 17. In certain embodiments, each of the layer of seeds 19 are chosen for their low invasiveness, high commercial availability, wide range of hardiness and drought tolerance, low toxicity for grazing animals, determinate vertical mature plant height, predictable gas exchange and consequential water aspiration, as well as carbon sequestration.

In at least one alternative embodiment of the present invention, the layer of seeds 19 have seeds from plants that include at least one of either avascular or non-vascular plant, a broadleaf or grass plants such as clover, a turf grasses (whether warm or cool season), a fern, a moss, and a succulent plant. It is understood that any other similar plants to those listed may also be included in the plurality of seeds and still remain within the intended scope of the claims for the embodiments of the present invention. The selected plants include either monocotyledon or eudicot; either monoculture or mixture; perennial, biennial or annual; ornamental or functional (such as having high nutritional or high wear properties); and in the form of seeds, seedlings, spores, or cuttings. Selected plants within the plant starting material layer may be mat-forming, upright, creeping, horizontal (including stolon or rhizome) or vertical stemmed, and grow by stolon or rhizome or seed transmission. The density of plant starting material layer 17 within the invention may be any level up to and including the recommended broadcast planting population density for the chosen plant material species.

In yet other embodiments, the layer of seeds 19 includes at least of either, Kentucky bluegrass [Poa Pratensis], Perennial Rye grass [Lolium perenne], white clover [Trifolium], or Cascade Stonecrop sedum [Sedum divergens] whose growth is determinate and whose portion of the shoot meristem 29 remains less than about 3 mm in height while the growing plant is in its embryonic, juvenile, and mature stages of life.

While in yet other embodiments of the present invention, the layer of seeds 19 is disposed in a manner that locates at least a portion of the seeds in contact with a surface of the plant starting material layer 17. It will be appreciated that wherever the layer of seeds 19 is disposed, at least a majority of the individual seeds 23 of the plurality of seeds is positioned such as to allow the individual seeds to reach the plant starting material layer 17 to allow the individual seeds to obtain the nutrients necessary needed to promote growth of the individual seeds.

It is noted that the broadcast density of the layer of seeds 19 located with the plant starting material layer 17 shall be as required to promote the greatest overall number of plants to project through any of the plurality of apertures 9 of the base attachment structure 25. With that in mind, it is understood the broadcast density of the individual seeds 23 of the layer of seeds 19 may be adjusted as needed for any specific plant type that may be included with the present embodiment.

With regard to the plurality of apertures 9 it is noted that the size, shape, and general location of the plurality of apertures within the base attachment structure 25 may be of any size, shape, and locations as required by the type of individual plant to be grown by the layer of seeds 19 as long as the size, shape, and locations of the plurality of apertures generally promote the required growth of the plant and be such that the embryonic plant germs may navigate through the plurality of apertures. In certain embodiments of the present invention, the perforation density is 50% by area wherein each of the plurality of apertures 9 has dimensions of about 10 mm×about 17 mm so as to permit the exchange of water, oxygen, and consequent growth of plant vascular tissue without strangulation of the growing plant while simultaneously providing adequate horizontal structure to locate and reinforce any shoot-like protrusions that form the base layer for the chosen plant meristem.

The plurality of upper elements 11 is designed to provide the approximate look and feel of natural vegetation and is constructed in such a way as to not totally block the plurality of growth apertures 9 when the plurality of upper elements are subjected to mechanical bending stress, thereby allowing plant growth by the distribution of the sun's radiation and gas exchange between the plant and the earth's atmosphere. In the present embodiment, each of the plurality of upper elements 11 has an elastic bending limit such that the intended foot or wheeled traffic does not permanently plastically deform the protrusion.

It is understood that the vertical upper base 13 protects the crown, sheath, and meristem plants grown from the layer of seeds 19 from mechanical shear by raising the shear plane such that when mechanical forces shear the plants, the plants can regenerate. The height of this vertical upper base 8 is determined by, and adjusted as needed, to match the specific height of the vital crown of the plants that will sprout from the plant disposed within the plant starting material layer 17. The vertical upper base 8 may be a separate element disposed near a bottom surface of the planet growing material, or in alternative embodiments the protective base may be a part of the plurality of upper elements 11.

More specifically, the plurality of upper elements 11 may be either a component that is separate from the vertical upper base 13 or the plurality of upper elements may be physically integrated and made of the same material as the base attachment structure 25. In each of these alternative embodiments, it is understood that plurality of upper elements 11 is designed and configured to approximate the general appearance of plants grown from the layer of seeds 19. It is also understood that the vertical upper base 13 must be formed either by its own structure or by the plurality of upper elements 11 and the vertical upper bases 13 forming a protective structure when any of the upper elements 11 are subjected to any mechanical bending stress. In one embodiment of the present invention, the plurality of upper elements 11 have a base attachment structure and internal cross-sectional structure 29.

The spacing, shape, bending strength, and wear resistance of the vertical protective base 8 are all engineered under specifications such that either grazing, foot or wheeled traffic do not meaningfully damage plant crown, shoot meristem, sheath, or other low-lying elements of plant anatomy of the selected plant that vital to the plant's establishment and continued success. Regardless of whether the protective base 15 is formed by the vertical elastic components under stress or constitutes its own structural element, it will have bending and wear resistance to withstand mechanical shear from foot (human or animal) and wheeled traffic (such as automobiles, bicycles, or lawn equipment), chewing, or other sources of mechanical shear. The height of the protective base 15 is selected to extend from the earth at a height greater than the selected plant shoot meristem 29, even when the base is formed by the plurality of upper elements 11 when under mechanical horizontal bending stress.

In the present embodiment, the plurality of upper elements 11 also has a vertical upper base 13 having an internal cross-sectional structure made from material that independently return to nominally upright vertical position, simulating the properties of natural vegetation.

Each of the plurality of upper elements 11 is constructed to mimic the appearance of natural vegetation of the plants selected for any embodiment of the present invention. Spacing and placement of each of the plurality of upper elements 11 may be in either a geometrical repeating pattern or in a random pattern. Spacing, shape, colors, and texture of longer upper elements 11 are crafted such that the nominal appearance of natural ground cover is achieved.

It is noted that in any of the above-noted embodiments of the present invention, the plant starting material layer 17, the plurality of apertures 9, the plurality of upper elements 11, and the height of the vertical upper bases 13 are configured and shaped to work in concert with the formulation of the plant starting material layer 17 such that it provides a solution that is easy to install, has a high likelihood of producing robust and plentiful vegetation, protects the plant from its vulnerable embryonic stage and throughout maturity, and looks like natural plant both immediately upon installation and in the event natural vegetation fails.

In at least one alternative embodiment of the present invention, the plant starting material layer 17 is a mixture of chopped natural pant fibers having a fiber length range between about 0.5 mm and about 3.0 mm and has diameter range of between about 0.02 mm and about 0.05 mm. The plant starting material layer 17 of the present embodiment includes an adhesive having between about 0.5% acrylamide copolymer by weight vs. natural fiber, and includes about 1% by weight of seeds from the layer of seeds 19.

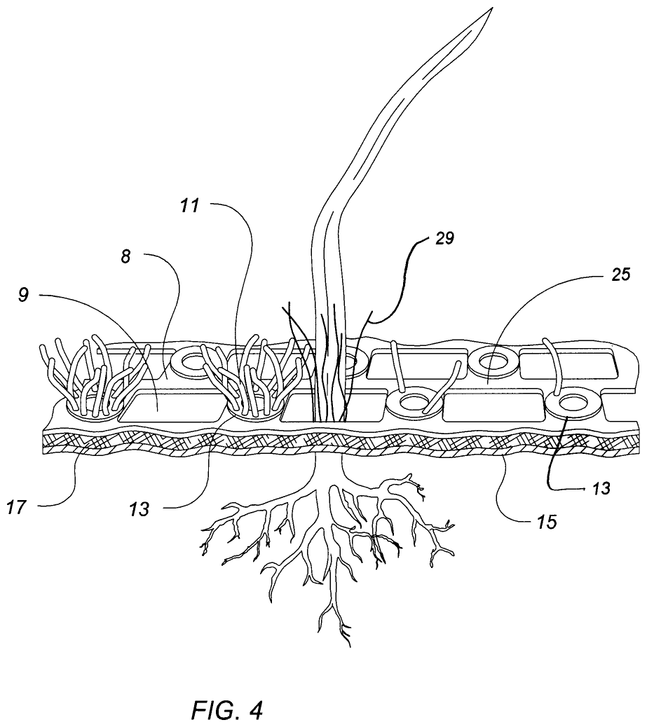

Certain embodiments of the present invention are installed in place with a suitable anchoring system of biodegradable stakes, such as an area with sufficient underlying growth substrate. Immediately upon installation, the plurality of upper elements 11 act as a visual approximation of established vegetation. As the integrated plant starting material layer 17 takes root and begins to develop a root structure, the vital root crown of the plane, the shoot meristem 29 (FIG. 4), and sheath are protected from mechanical shear by raising the shear plane to the height of the base, thereby encouraging robust vegetation growth and protecting the plants where they are most vulnerable to mechanical stresses inclusive of mechanical shear caused by foot and wheel traffic. The plants then grow through the invention's apertures and sprout through the mat itself.

In the above descriptions a preferred embodiment is disclosed. It is understood that there can be a number of alternative preferred embodiments of the present invention. Some of those alternative preferred embodiments are disclosed in the following descriptions. It is understood that each of the following alternative preferred embodiments is as described in the above disclosure but differs in the detailed descriptions of each alternative embodiment as disclosed below.

In a first alternative (See FIG. 2 and FIG. 3) preferred embodiment of the present invention, the selected set of elements of that embodiment includes a protective base 15, a plant starting material layer 17, a layer of seeds 19, and a base attachment structure 25. These selected elements are arranged vertically as substantially shown in FIG. 3 with the exception that the organization of the selected elements will have a vertical order different than as shown in FIG. 3 and will contain the elements from the current set of selected elements for this current embodiment.

More specifically, this first alternative preferred embodiment of the present invention comprises a vertical arrangement and sequence of the selected set of elements in the following vertical order beginning at the bottom of this first alternative embodiment; a protective layer 15, a plant starting material layer 17 wherein the layer of plant seeds 19 is disposed within the plant starting material layer, and a base attachment structure 25 having a plurality of apertures 2 and a plurality of vertical supports 13 wherein one of the plurality of upper elements 11 is disposed within each of the vertical supports, and a base attachment structure.

In a second alternative preferred embodiment of the present invention, the selected set of elements of this second embodiment includes a plant starting material layer 17, a layer of seeds 19, and a base attachment structure 25. These selected elements are arranged vertically similar to the vertical arrangement of the first alternative embodiment with the exception that the organization of the selected elements will have a vertical order different than disclosed for the first alternative embodiment but will contain the elements from the current set of selected elements for this second alternative embodiment.

The second alternative embodiment of the present invention comprises a vertical arrangement and sequence of the selected set of elements in the following vertical order beginning at the bottom of this second alternative embodiment; a plant starting material layer 17 wherein the layer of plant seeds 19 is disposed within the plant starting material layer, and a base attachment structure 25 having a plurality of apertures 2 and a plurality of vertical supports 13 wherein one of the plurality of upper elements 11 is disposed within each of the vertical supports.

In a third alternative preferred embodiment of the present invention, the selected set of elements of this third embodiment includes a protective base 15, a plant starting material layer 17, a layer of seeds 19, and a base attachment structure 25. These selected elements are arranged vertically similar to the vertical arrangement of the first alternative embodiment with the exception that the organization of the selected elements will have a vertical order different than disclosed for the first alternative embodiment but will contain the elements from the current set of selected elements for this second alternative embodiment.

The third alternative embodiment of the present invention comprises a vertical arrangement and sequence of the selected set of elements in the following vertical order beginning at the bottom of this second alternative embodiment; a protective base 15, a base attachment structure 25 having a plurality of apertures 2 and a plurality of vertical supports 13 wherein one of the plurality of upper elements 11 is disposed within each of the vertical supports, and a plant starting material layer 17 wherein the layer of plant seeds 19 is disposed within the plant starting material layer.

In a fourth alternative preferred embodiment of the present invention, the selected set of elements of this fourth embodiment includes a plant starting material layer 17, a layer of seeds 19, and a base attachment structure 25. These selected elements are arranged vertically similar to the vertical arrangement of the first alternative embodiment with the exception that the organization of the selected elements will have a vertical order different than disclosed for the first alternative embodiment but will contain the elements from the current set of selected elements for this second alternative embodiment.

The fourth third alternative embodiment of the present invention comprises a vertical arrangement and sequence of the selected set of elements in the following vertical order beginning at the bottom of this second alternative embodiment; a base attachment structure 25 having a plurality of apertures 2 and a plurality of vertical supports 13 wherein one of the plurality of upper elements 11 is disposed within each of the vertical supports, a plant starting material layer 17 wherein the layer of plant seeds 19 is disposed within the plant starting material layer.

In a fifth alternative preferred embodiment of the present invention, the selected set of elements of this embodiment includes a protective base 15, a plant starting material layer 17, a layer of seeds 19, and a base attachment structure 25. These selected elements are arranged vertically similar to the vertical arrangement of the first alternative embodiment with the exception that the organization of the selected elements will have a vertical order different than disclosed for the first alternative embodiment but will contain the elements from the current set of selected elements for this second alternative embodiment.

The fifth alternative embodiment of the present invention comprises a vertical arrangement and sequence of the selected set of elements in the following vertical order beginning at the bottom of this second alternative embodiment; a protective base 15, a base attachment structure 25 having a plurality of apertures 2 and a plurality of vertical supports 13 wherein each of the plurality of upper elements 11 is disposed adjacent to the vertical supports and disposed on an upper surface 8 of the base attachment structure, and a plant starting material layer 17 wherein the layer of plant seeds 19 is disposed within the plant starting material layer.

In a sixth alternative preferred embodiment of the present invention, the selected set of elements of this embodiment includes a plant starting material layer 17, a layer of seeds 19, and a base attachment structure 25. These selected elements are arranged vertically similar to the vertical arrangement of the first alternative embodiment with the exception that the organization of the selected elements will have a vertical order different than disclosed for the first alternative embodiment but will contain the elements from the current set of selected elements for this second alternative embodiment.

The sixth alternative embodiment of the present invention comprises a vertical arrangement and sequence of the selected set of elements in the following vertical order beginning at the bottom of this second alternative embodiment; a base attachment structure 25 having a plurality of apertures 2 and a plurality of vertical supports 13 wherein each of the plurality of upper elements 11 is disposed adjacent to the vertical supports and disposed on an upper surface 8 of the base attachment structure, and a plant starting material layer 17 wherein the layer of plant seeds 19 is disposed within the plant starting material layer.

In a seventh alternative preferred embodiment of the present invention, the selected set of elements of this embodiment includes a plant starting material layer 17, a layer of seeds 19, and a base attachment structure 25. These selected elements are arranged vertically similar to the vertical arrangement of the first alternative embodiment with the exception that the organization of the selected elements will have a vertical order different than disclosed for the first alternative embodiment but will contain the elements from the current set of selected elements for this second alternative embodiment.

The seventh alternative embodiment of the present invention comprises a vertical arrangement and sequence of the selected set of elements in the following vertical order beginning at the bottom of this second alternative embodiment; a plant starting material layer 17 wherein the layer of plant seeds 19 is disposed within the plant starting material layer, and a base attachment structure 25 having a plurality of apertures 2 and a plurality of vertical supports 13 wherein each of the plurality of upper elements 11 is disposed adjacent to the vertical supports and disposed on an upper surface 8 of the base attachment structure.

In an eighth alternative preferred embodiment of the present invention, the selected set of elements of this embodiment includes a protective base 15, a plant starting material layer 17, a layer of seeds 19, and a base attachment structure 25. These selected elements are arranged vertically similar to the vertical arrangement of the first alternative embodiment with the exception that the organization of the selected elements will have a vertical order different than disclosed for the first alternative embodiment but will contain the elements from the current set of selected elements for this second alternative embodiment.

The eighth alternative embodiment of the present invention comprises a vertical arrangement and sequence of the selected set of elements in the following vertical order beginning at the bottom of this second alternative embodiment; a protective base 15, a plant starting material layer 17 wherein the layer of plant seeds 19 is disposed within the plant starting material layer, and a base attachment structure 25 having a plurality of apertures 2 and a plurality of vertical supports 13 wherein each of the plurality of upper elements 11 is disposed adjacent to the vertical supports and disposed on an upper surface 8 of the base attachment structure.

In a ninth alternative preferred embodiment of the present invention, the selected set of elements of this embodiment includes a protective base 15, a plant starting material layer 17, a layer of seeds 19, and a base attachment structure 25. These selected elements are arranged vertically similar to the vertical arrangement of the first alternative embodiment with the exception that the organization of the selected elements will have a vertical order different than disclosed for the first alternative embodiment but will contain the elements from the current set of selected elements for this second alternative embodiment.

The ninth alternative embodiment of the present invention comprises a vertical arrangement and sequence of the selected set of elements in the following vertical order beginning at the bottom of this alternative embodiment; a protective base 15, the layer of plant seeds 19, a plant starting material layer 17, and a base attachment structure 25 having a plurality of apertures 2 and a plurality of vertical supports 13 wherein each of the plurality of upper elements 11 is disposed adjacent to the vertical supports and disposed on an upper surface 8 of the base attachment structure.

It is understood that yet other alternative embodiments that combine yet other sets of selected elements can be arranged and adjusted that are still within the intended scope of the present claims.

In the preceding description, numerous specific details are set forth such as examples of specific components, devices, and methods in order to provide a thorough understanding of embodiments of the present disclosure. It will be apparent to a person of ordinary skill in the art that these specific details need not be employed, and should not be construed to limit the scope of the disclosure. In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication, and manufacture for those of ordinary skill. The scope of the invention should be determined by any appended claims and their legal equivalents, rather than by the examples given.

Additionally, it will be seen in the above disclosure that several of the intended purposes of the invention are achieved, and other advantageous and useful results are attained. As various changes could be made in the above constructions without departing from the scope of the invention, it is intended that all matter contained in the above descriptions or shown in the accompanying drawings shall be interpreted as illustrative and not in a limiting sense.

Terms such as “proximate,” “distal,” “upper,” “lower,” “inner,” “outer,” “inwardly,” “outwardly,” “exterior,” “interior,” and the like when used herein refer to positions of the respective elements as they are shown in the accompanying drawings, and the disclosure is not necessarily limited to such positions. Terms such as “first,” “second,” and other numerical terms when used herein do not imply a sequence or order unless clearly indicated by the context.

When introducing elements or features and the exemplary embodiments, the articles “a,” “an,” “the” and “said” are intended to mean that there are one or more of such elements or features. The terms “comprising,” “including,” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It will also be understood that when an element is referred to as being “operatively connected,” “connected,” “coupled,” “engaged,” or “engageable” to and/or with another element, it can be directly connected, coupled, engaged, engageable to and/or with the other element or intervening elements may be present. In contrast, when an element is referred to as being “directly connected,” “directly coupled,” “directly engaged,” or “directly engageable” to another element, there are no intervening elements present. Other words used to describe the relationship between elements should be interpreted in a like fashion (e.g., “between” versus “directly between,” “adjacent” versus “directly adjacent,” etc.).

What is claimed is:

1. A three-dimensional ground vegetation reinforcement structure comprising:
a base attachment structure having;
an upper portion,
a plurality of apertures,
a plurality of upper elements that are generally resilient when bent and flexed,
a plurality of vertical upper bases disposed on the upper surface of the base attachment structure,
a plant starting material layer disposed one of either on the upper surface of the base attachment structure, and on the bottom surface of the base attachment structure, and,
a layer of plant seeds disposed one of either on, within, or near a bottom surface of the plant starting material.

2. The three-dimensional ground vegetation reinforcement structure of claim 1 further comprising a protective base disposed near the bottom of the base attachment structure.

3. The three-dimensional ground vegetation reinforcement structure of claim 1 wherein each of the plurality of upper elements is independently resilient and biased to remain generally upright after being positioned into a non-vertical position.

4. The three-dimensional ground vegetation reinforcement structure of claim 1 wherein the plurality of upper elements is designed to provide the approximate look and feel of natural vegetation and is constructed as to not totally block the plurality of apertures.

5. The three-dimensional ground vegetation reinforcement structure of claim 4 wherein each of the plurality of upper elements is made from a Low Density Polyethylene (LDPE) material, wherein each of the plurality of upper elements is about 20 mm in height, about 2 mm wide, and about 1 mm thick near a lower portion of each of the upper elements such that each of the upper elements has a taper between about 1.5 mm and about 0.5 mm thick at an upper portion of the upper elements, and wherein each of the plurality of upper elements has a monomeric cross-section that is symmetric about one axis such as to simulate a turf grass leaf.

6. The three-dimensional ground vegetation reinforcement structure of claim 1 wherein the plant starting material is one of either sputtered upon the protective base, sprayed as a slurry on the protective base, or generally distributed upon the protective base.

7. The three-dimensional ground vegetation reinforcement structure of claim 6 wherein the plant starting material is made generally composed of at least one of either earth soil and a mixture of chopped natural pant fibers having a fiber length range between about 0.5 mm and about 3.0 mm and has a diameter range of between about 0.02 mm and about 0.05 mm, wherein the plant starting material includes an adhesive having between about 0.5% acrylamide copolymer by weight of the natural fiber, and includes about 1% by weight of seeds from the layer of seeds.

8. The three-dimensional ground vegetation reinforcement structure of claim 7 wherein the general composition of the layer of seeds includes at least one of either plant seeds, plant seedlings, plant cuttings, ground-up plant material, spores, and any other organic material capable of germinating and growing through the plurality of apertures disposed in the base attachment structure.

9. The three-dimensional ground vegetation reinforcement structure of claim 8 wherein the layer of seeds is one of either disposed in a manner that locates at least a portion of the plant seeds a distance away from the layer of plant starting material and in a manner where at least a portion of the seeds is in contact with a surface of the plant starting material.

10. The three-dimensional ground vegetation reinforcement structure of claim 8 wherein the layer of seeds includes seeds from plants that include at least one of either a vascular plant, a non-vascular plant, a broadleaf plant, a clover plant, a turf grass, a fern, a moss, and a succulent plant.

11. A three-dimensional ground vegetation reinforcement structure comprising:
a base attachment structure a plurality of apertures, a plurality of vertical upper bases, a plurality of upper elements, a plant starting material layer, and a layer of plant seeds.

12. The ground vegetation reinforcement structure of claim 1 wherein the plurality of upper elements is one of either disposed on the base attachment structure, the upper surface of the base attachment structure, and on a distal end of each of the plurality of vertical upper bases.

13. The ground vegetation reinforcement structure of claim 10 wherein the plant starting material layer is disposed one of either below the base attachment structure and above the base attachment structure.

14. The ground vegetation reinforcement structure of claim 10 wherein the layer of plant seeds is disposed one of either below the plant starting layer, above the plant starting layer, and within the plant starting layer.

15. The ground vegetation reinforcement structure of claim 10 further comprising a protective layer disposed at the bottom of one of either the plant starting layer and the base attachment structure.
